(19) United States
(12) Patent Application Publication
(10) Pub. No.: US 2022/0151373 A1
(43) Pub. Date: May 19, 2022

(54) PAINT BRUSH PRESSURIZED CLEANING SYSTEM

(71) Applicants: Stephanie Young, Londonderry, NH (US); Michael P. Aprea, Plymouth, MA (US)

(72) Inventors: Stephanie Young, Londonderry, NH (US); Michael P. Aprea, Plymouth, MA (US)

(21) Appl. No.: 17/528,793

(22) Filed: Nov. 17, 2021

Related U.S. Application Data
(60) Provisional application No. 63/115,315, filed on Nov. 18, 2020.

(51) Int. Cl. A46B 17/06; B08B 1/00; B08B 3/02

(52) U.S. Cl. CPC A46B 17/06; B08B 1/002; B08B 2203/0211; A46B 2200/202; B08B 3/02

(57) ABSTRACT

An apparatus includes a top cover having a first side and a second side, the second side opposite the first side, the top cover tapered and comprising an opening at a top of the tapered portion to accept a paint brush handle within and two flexible tabs on a lower portion of the first side, and a bottom cover having a first side and a second side, the second side opposite the first side, the first side of the bottom cover comprising two slots positioned on a top portion, the bottom cover configured to accept a paint brush bristle portion within, a lower part of the tapered portion of the top cover configured to releasably lock to the bottom cover when the two flexible tabs are engaged within the two slots.

### CROSS REFERENCE TO RELATED APPLICATIONS

This application claims benefit from U.S. Provisional Patent Application Ser. No. 63/115,315, filed Nov. 18, 2020, which is incorporated by reference in its entirety.

### BACKGROUND OF THE INVENTION

The present invention is directed to a clean device. More particularly, the present invention is directed to paint brush pressurized cleaning.

In general, this invention relates in general to the problem of cleaning regular and sponge type paint brushes, paint rollers and pad applicators. It is difficult to flush the paint out of regular and sponge type paint brushes, paint rollers and pad applicators by shaking in a container of water or solvent or holding them under running water. There is a large amount of paint in the bristles of the brushes and the nap of the rollers and pads, making them difficult to clean properly. There is a tendency to buy cheap brushes, rollers and pads and throw them away after each use because of the difficulties in cleaning them. A good paint job requires good paint brushes, rollers and pads.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In general, in one aspect, the invention features an apparatus including a top cover having a first side and a second side, the second side opposite the first side, the top cover tapered and including an opening at a top of the tapered portion to accept a paint brush handle within and two flexible tabs on a lower portion of the first side, and a bottom cover having a first side and a second side, the second side opposite the first side, the first side of the bottom cover including two slots positioned on a top portion, the bottom cover configured to accept a paint brush bristle portion within, a lower part of the tapered portion of the top cover configured to releasably lock to the bottom cover when the two flexible tabs are engaged within the two slots.

In another aspect, the invention features an apparatus including a hard top cover having a first side and a second side, the second side opposite the first side, the top cover tapered and including an opening at a top of the tapered portion to accept a paint brush handle within and two tabs located opposite each other on a lower collar, and a soft bottom cover having a first side and a second side, the second side opposite the first side, the bottom cover including two slots positioned on a top portion, the bottom cover configured to accept a paint brush bristle portion within, a lower part of the tapered portion of the top cover configured to releasably lock to the bottom cover when the two tabs are engaged within the two slots.

In still another aspect, the invention features an apparatus including a container having a first side and a second side, the second side opposite the first side, the container including an upper opening to accept a bristles portion of a paint brush, the first side of the container including a water hose attachment, the second side of bottom cover including a plurality of projections, and a distal portion of a bottom of the container including a plurality of drain apertures.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 illustrates a first side of an exemplary a pressurized paint brush and water hose holder.

FIG. 2 illustrates a second side of the exemplary a pressurized paint brush and water hose holder of FIG. 1.

FIG. 3 illustrates a side view cross-section of the exemplary the pressurized paint brush and water hose holder of FIG. 1.

FIG. 4 illustrates a bottom view of a bottom cover.

FIG. 5 illustrates an open view of the pressurized paint brush and water hose holder.

FIG. 6 illustrates a first side of a second embodiment of an exemplary pressurized paint brush and water hose holder.

FIG. 7 illustrates the bottom cover of the pressurized paint brush and water hose holder of FIG. 6.

FIG. 8 illustrates a first side of a third embodiment of an exemplary pressurized paint brush and water hose holder.

FIG. 9 illustrates a second side of the exemplary a pressurized paint brush and water hose holder of FIG. 8.

FIG. 10 illustrates the bottom cover of the pressurized paint brush and water hose holder of FIG. 8.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

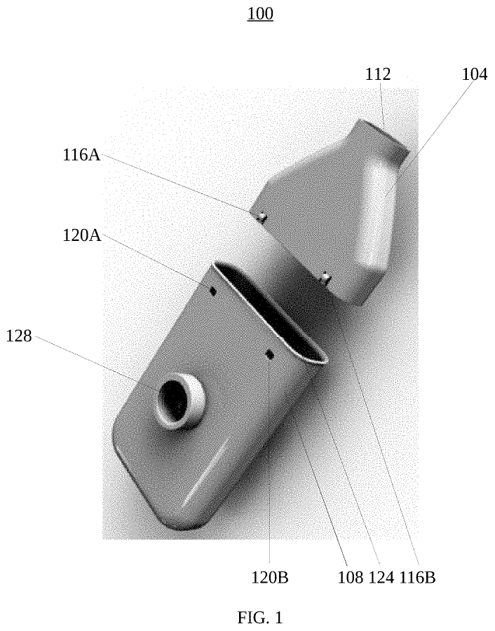

As shown in FIG. 1, a prospective of a first side of an exemplary a pressurized paint brush and water hose holder 100 includes a top cover 104 and a bottom cover 108. The top cover 104 and bottom cover 108, in one embodiment, are made of a hard plastic material which can take repeated clamping without cracking. The top cover 104 is tapered and includes has a top opening 112 at the top of the tapered portion to accept a brush handle (not shown). A lower part of the tapered portion of the top cover 104 is configured to slide into an aperture 124 on a proximal end of the bottom cover 108.

More specifically, the first side of the top cover 104 includes two flexible tabs 116A, 116B. The first side of the bottom cover 108 includes two apertures or slots 120A, 120B at a base of its taper. The two flexible tabs 116A, 116B are engaged and locked into respective slots 120A, 120B when the top cover 104 is placed withing the bottom cover 108. The top cover 104 may be released from the lower cover 108 by pressing on the flexible tabs 116A, 116B, disengaging them from slots 120A, 120B.

The bottom cover 101 also includes a hose attachment 128. The hose attachment 128 is configured to receive a standard garden hose (not shown). As such, in one embodiment, the hose attachment 128 is threaded.

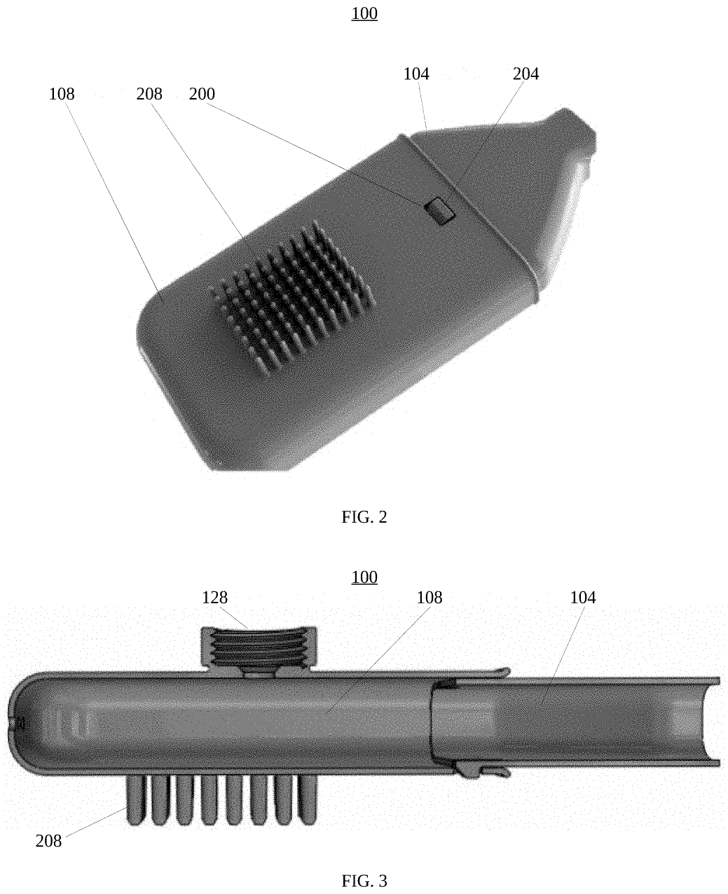

In FIG. 2, a prospective of a second, i.e., opposite, side of the exemplary a pressurized paint brush and water hose holder 100 illustrates the top cover 104 snapped into the bottom cover 108. In this embodiment, the second side of the top cover 104 includes a tab 200 engaged into a slot 204 present on the second side of the bottom cover 108. As in this embodiment, the second side of the bottom cover 108 also includes posts or projections 208. The projections 208 can be used as a comb to break up dried paint on a paint brush before the paint brush is placed in the pressurized paint brush and water hose holder.

In FIG. 3, a side view cross-section of the exemplary a pressurized paint brush and water hose holder 100 is shown where the top cover 104 is engaged with the bottom cover 108. Here, the hose connection 128 and the projections 208 are shown in greater detail.

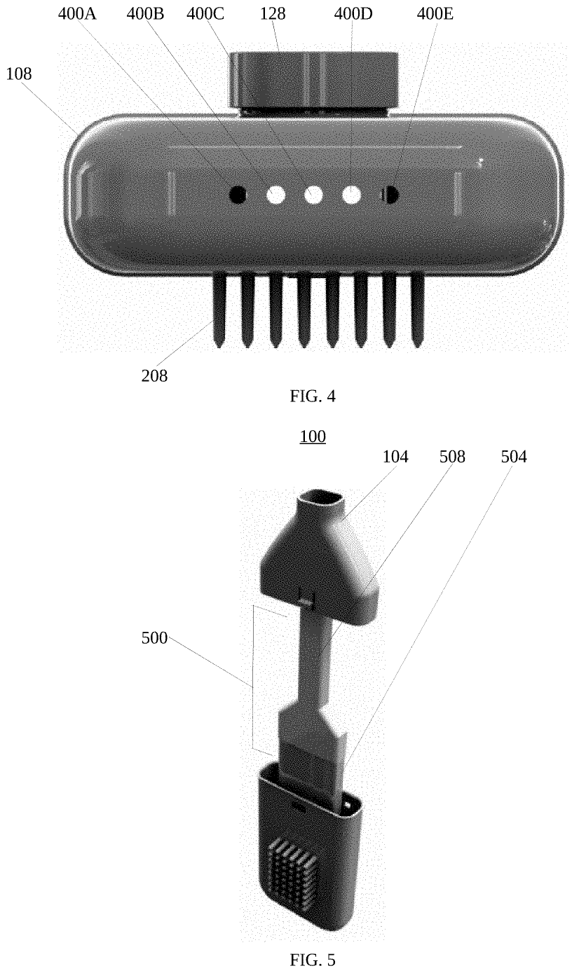

As shown FIG. 4, a bottom view of the bottom cover 108 includes a series of drain apertures 400A, 400B, 400C, 400D. The drain apertures 400A, 400B, 400C, 400D, 400E serve as an exit for water introduced through the hose attachment 128. Although four circular drain apertures are illustrated, it should be appreciated that other embodiments of the invention may include any number of drain apertures, and the drain apertures can be configured into various sizes and shapes. Moreover, the top cover 104 may include one or more drain apertures to aid in draining water introduced through the hose attachment 128.

As shown in FIG. 5, an exemplary paint brush 500 typically includes a brush portion 504 and a handle portion 508. The bottom cover 108 is configured to receive the brush portion 504 and the top cover 104 configured to cover the handle portion 508. When paint brush 500 is placed within bottom cover 108, the top cover 104 is snapped into the bottom cover 108 and secure holds the paint brush in place.

More specifically, in operation, a user inserts the brush portion 504 into the bottom cover 108 and then inserts the top cover 104 over the handle portion 508 and onto the bottom cover 108 until the covers 104, 108 snap together. The user then attaches a water hose to the hose attachment 128 of bottom cover 108. Water is introduced through the hose attachment, over the brush portion 504, and exiting the drain the apertures 400A, 400B, 400C, 400D, 400E of the bottom cover 108. To remove the paint brush 500, the user presses down on the flexible tabs 116A, 116B, removing the top cover 104 from the bottom cover 108, releasing the paint brush 500 brush from the pressurized paint brush and water hose holder 100.

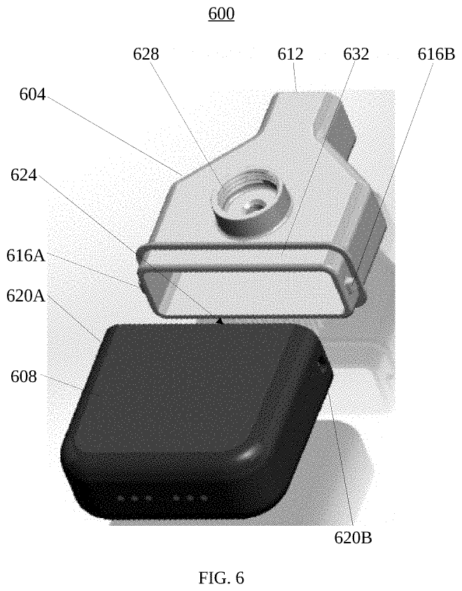

Referring now to FIG. 6, in a second embodiment, a prospective of a first side of an exemplary a pressurized paint brush and water hose holder 600 includes a top cover 604 and a bottom cover 608. The top cover 604 is made of a hard plastic material which can take repeated clamping without cracking. The bottom cover 608 is made of a soft thermoplastic elastomer material which can take repeated clamping without cracking.

The top cover 604 is tapered and includes has a top opening 612 at the top of the tapered portion to accept a brush handle (not shown). A lower part of the tapered portion of the top cover 604 is configured to slide into an aperture 624 on a proximal end of the bottom cover 608.

More specifically, the first side of the top cover 604 includes two tabs 616A, 616B. The bottom cover 108 includes two apertures or slots 620A, 620B at a base of its taper. The two tabs 616A, 616B are engaged and locked into respective slots 620A, 620B when the top cover 104 is placed withing the bottom cover 108. The top cover 104 may be released from the lower cover 108 by pressing on the flexible tabs 116A, 116B, disengaging them from slots 120A, 120B.

The top cover 604, has on one surface, threads 628 molded into it that a water hose can attach to. The top cover 604 has on an opposite surface, as described in the first embodiment above, an area of molded in posts used as a comb to break up dried paint on a paint brush before the brush is cleaned with water.

The top cover 604 also includes a rim 632 around the entire body that allows the soft bottom cover 108 to meet the rim 632, providing a sealing surface to aid in keeping water from rushing out between the top cover 604 and the bottom cover 608.

As shown in FIG. 7, the bottom cover 608 at the bottom has apertures or drain holes 700A, 700B, 700C, 700 D, 700E, 700F to enable water to drain while a paint brush is being cleaned. In operation, a user inserts a paint brush bristles into the bottom cover 608 and then inserts the top cover 604 over a paint brush handle and onto the bottom cover 608 until the covers 604, 608 snap together. The user attaches a water hose to the top cover 604 using the threads 628 and then tightens the water hose nozzle to lock in place. Water is then allowed to enter the top cover 604, over the paint brush bristles, and exit the drain holes 700A, 700B, 700C, 700 D, 700E, 700F. To assist and make it even faster to clean the brush, using a free hand to squeeze the bottom cover 608 against the bristles of the brush to work the paint from the brush. To remove the cleaned paint brush, the user presses on the soft bottom cover 608 near the tabs 616A, 616B, removing the top cover 604 from the bottom cover 608, releasing the brush.

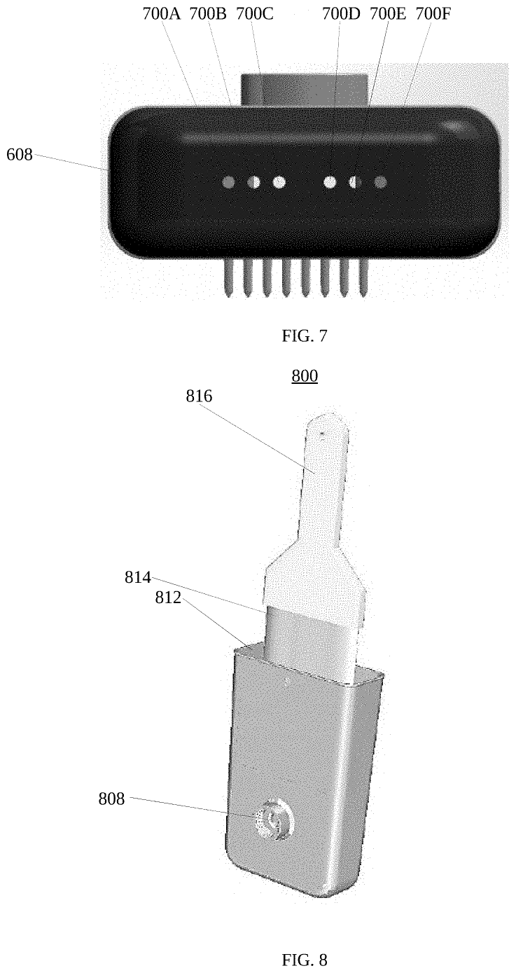

Referring now to FIG. 8, in a third embodiment, a prospective of a first side of an exemplary a pressurized paint brush and water hose holder 800 includes a container or holder 804. On the first side, the holder 804 includes threads 808 molded in a fashion to receive a water hose. The holder 804 includes an upper opening 812 configured to receive a bristles portion 814 of a paint brush 816.

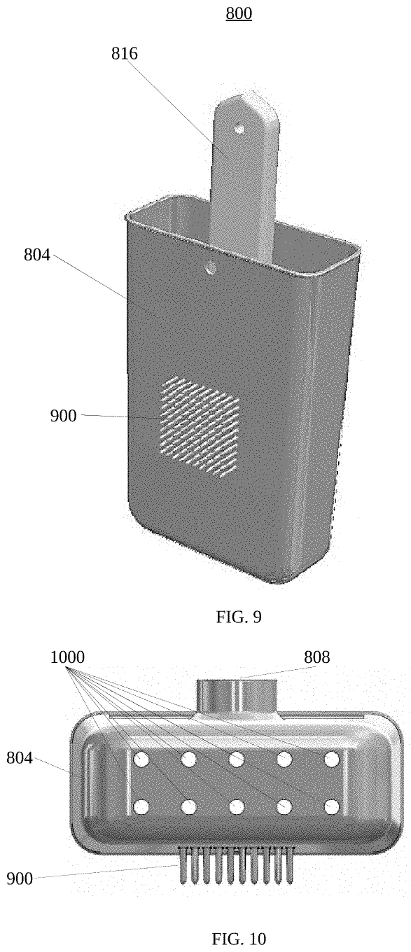

As shown in FIG. 9, on a second (i.e., reverse) side, the holder 804 includes an area of molded in posts 900 that may be used as a comb to break up dried paint on a paint brush before the brush is cleaned with water.

As shown in FIG. 10, a bottom of the holder 804 includes holes 1000 to allow water to drain while the paint brush is being cleaned. In embodiments, the holder 804 may include a rim around its entire body to stiffen the body.

The holder 804 is configured to be at a correct height so that during operation the water from the water hose keeps water from rushing out as the user methodically raises and lowers the brush handle.

In operation, the user inserts the paint brush bristles 814 into the holder 804. When finished, the user simply attaches a water hose to the holder 804 using the provided threads 808 and then tightens the water hose to lock the members in place. To assist and make it even faster to clean the brush 816, using a free hand one can methodically raise and lower the brush handle 816 to agitate the water against the bristles 814 of the brush to work the paint from the brush. When done, remove the paint brush is removed and the can disconnect the water hose by unscrewing it from the threads 808.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. An apparatus comprising:
a top cover having a first side and a second side, the second side opposite the first side, the top cover tapered and comprising an opening at a top of the tapered portion to accept a paint brush handle within and two flexible tabs on a lower portion of the first side; and
a bottom cover having a first side and a second side, the second side opposite the first side, the first side of the bottom cover comprising two slots positioned on a top portion, the bottom cover configured to accept a paint brush bristle portion within,
a lower part of the tapered portion of the top cover configured to releasably lock to the bottom cover when the two flexible tabs are engaged within the two slots.

2. The apparatus of claim 1 wherein the first side of the bottom cover includes a water hose attachment.

3. The apparatus of claim 2 wherein the water hose attachment is configured to receive a garden water hose.

4. The apparatus of claim 2 wherein the second side of bottom cover includes a plurality of projections.

5. The apparatus of claim 4 wherein a distal portion of the bottom cover includes a plurality of drain apertures.

6. The apparatus of claim 5 wherein the plurality of drain apertures provide an exit for water introduced through the water hose attachment.

7. The apparatus of claim 1 wherein the top cover and the bottom cover are made of a hard plastic material.

8. An apparatus comprising:
a hard top cover having a first side and a second side, the second side opposite the first side, the top cover tapered and comprising an opening at a top of the tapered portion to accept a paint brush handle within and two tabs located opposite each other on a lower collar; and
a soft bottom cover having a first side and a second side, the second side opposite the first side, the bottom cover comprising two slots positioned on a top portion, the bottom cover configured to accept a paint brush bristle portion within,
a lower part of the tapered portion of the top cover configured to releasably lock to the bottom cover when the two tabs are engaged within the two slots.

9. The apparatus of claim 8 wherein the first side of the hard top cover includes a water hose attachment.

10. The apparatus of claim 9 wherein the water hose attachment is configured to receive a garden water hose.

11. The apparatus of claim 9 wherein the second side of soft bottom cover includes a plurality of projections.

12. The apparatus of claim 4 wherein a distal portion of the bottom cover includes a plurality of drain apertures.

13. The apparatus of claim 12 wherein the plurality of drain apertures provide an exit for water introduced through the water hose attachment.

14. The apparatus of claim 8 wherein the soft bottom cover in constructed from a soft thermoplastic elastomer material.

15. An apparatus comprising:
a container having a first side and a second side, the second side opposite the first side, the container comprising an upper opening to accept a bristles portion of a paint brush,
the first side of the container including a water hose attachment,
the second side of bottom cover including a plurality of projections, and
a distal portion of a bottom of the container including a plurality of drain apertures.

16. The apparatus of claim 15 wherein the water hose attachment is configured to receive a garden water hose.

17. The apparatus of claim 15 wherein the plurality of drain apertures provide an exit for water introduced through the water hose attachment.

18. The apparatus of claim 15 wherein the container is constructed from a hard plastic material.
